(19) United States
(12) Patent Application Publication
(10) Pub. No.: US 2010/0045678 A1
(43) Pub. Date: Feb. 25, 2010

(54) IMAGE CAPTURE AND PLAYBACK

(75) Inventor: Luke Reid, Dunedin (NZ)

Correspondence Address: BAINWOOD HUANG & ASSOCIATES LLC, 2 CONNECTOR ROAD, WESTBOROUGH, MA, 01581, US

(73) Assignee: AREOGRAPH LTD, Dunedin (NZ)

(21) Appl. No.: 12/554,457

(22) Filed: Sep. 4, 2009

Related U.S. Application Data
(63) Continuation of application No. PCT/IB2008/000525, filed on Mar. 6, 2008.

(30) Foreign Application Priority Data
Mar. 6, 2007 (GB) 0704319.3

(51) Int. Cl. G06T 15/20

(52) U.S. Cl. 345/427; 345/419

(57) ABSTRACT

A video signal is generated having a moving image as a series of playback frames and representing movement of a viewer through a computer-generated virtual scene which is generated using stored images by taking the stored images to have different viewpoints within the virtual scene. The video signal is generated by selecting a first stored image based on the selection of a first viewpoint, generating a first playback frame using the first stored image, selecting a next viewpoint from a set of potential next viewpoints distributed relative to the first viewpoint across the virtual scene, selecting a second stored image on the basis of the selected next viewpoint, and generating a subsequent playback frame using the second stored image. The image data is captured by capturing a set of images based on the selection of a set of points of capture, wherein at least some of the points of capture are distributed with a substantially constant or substantially smoothly varying average density across a first two-dimensional area.

### BACKGROUND OF THE INVENTION

The present invention relates to capturing image data and subsequently generating a video signal comprising a moving image in the form of a series of playback frames.

Traditional video capture and playback uses a video camera which captures images in the form of a series of video frames, which are then stored and played back in the same sequence in which they are captured. Whilst developments in recording and playback technology allow the frames to be accessed separately, and in a non-sequential order, the main mode of playback is sequential, in the order in which they are recorded and/or edited. In terms of accessing frames in non-sequential order, interactive video techniques have been developed, and in optical recording technology, it is possible to view selected frames distributed through the body of the content, in a preview function. This is, however, a subsidiary function which supports the main function of playing back the frames in the order in which they are captured and/or edited.

Computer generation is an alternative technique for generating video signals. Computer generation is used in video games, simulators and movies. In computer generation the video signals are computer-generated from a three dimensional (3D) representation of the scene, typically in the form of an object model, and by then applying geometry, viewpoint, texture and lighting information. Rendering may be conducted non-real time, in which case it is referred to as pre-rendering, or in real time. Pre-rendering is a computationally intensive process that is typically used for movie creation, while real-time rendering is used for video games and simulators. For video games and simulators, the playback equipment typically uses graphics cards with 3D hardware accelerators to perform the real-time rendering.

The process of capturing the object model for a computer-generated scene has always been relatively intensive, particularly when it is desired to generate photorealistic scenes, or complex stylized scenes. It typically involves a very large number of man hours of work by highly experienced programmers. This applies not only to the models for the moving characters and other moving objects within the scene, but also to the background environment. As video game consoles, computers and movie generation techniques become more capable of generating complex scenes, and Capable of generating scenes which are more and more photorealistic, the cost of capturing the object model has correspondingly increased, and the initial development cost of a video game, simulator or computer generated movie, is constantly increasing. Also, the development time has increased, which is particularly disadvantageous when time-to-market is important.

It is an object of the invention to improve computer generation techniques for video.

### SUMMARY OF THE INVENTION

The present invention is set out in the appended claims.

An advantage of the invention is that highly photorealistic, or complex stylized, scenes can be generated in a video playback environment, whilst a viewer or other view-controlling entity can arbitrarily select a viewing position, according to movement through the scenes in any direction in at least a two dimensional space. Thus, a series of viewpoints can be chosen (or example in a video game the player can move their character or other viewing entity through the computer-generated scene), without the need for complex rendering of the entire scene from an object model. At each viewpoint, a stored image is used to generate the scene as viewed in that position. Using the present invention, scenes can be captured with a fraction of the initial development cost and initial development time required using known techniques. Also, the scenes can be played back at highly photorealistic levels without requiring as much rendering as computer generation techniques relying purely on object models.

The invention may be used in pre-rendering, or in real time rendering. The stored images themselves may be captured using photographic equipment, or may be captured using other techniques, for example an image may be generated at each viewpoint using computer generation techniques, and then each generated image stored for subsequent playback using a method according to the present invention.

The techniques of the present invention may be used in conjunction with object modelling techniques. For example, stored images may be used to generate the background scene whilst moving objects such as characters may be overlaid on the background scene using object models. In this regard, object model data is preferably stored with the stored images, and used for overlaying moving object images correctly on the computer-generated scenes generated from the stored images.

Preferably, the captured images comprise images with a 360° horizontal field of view. In this way, the viewing direction can be selected arbitrarily, without restriction, at each viewpoint. The technique of the present invention preferably involves selecting a suitable part of the captured image for playback, once the stored image has been selected on the basis of the current location of view.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A shows a grid pattern used for image capture and playback according to an embodiment of the invention; and

FIG. 1B shows a grid pattern used for image capture and playback according to an alternative embodiment of the invention;

FIG. 2 shows image capture apparatus according to a first embodiment of the invention;

FIG. 3 shows a panoramic lens arrangement for use in an image capture apparatus according to the first embodiment of the invention;

FIG. 4 is a schematic block diagram of elements of an image capture apparatus in accordance with the first embodiment of the present invention;

FIG. 5 shows image capture apparatus according to a second embodiment of the invention;

FIG. 6 is a schematic block diagram of elements of video playback apparatus in accordance with an embodiment of the present invention;

FIG. 7 shows a schematic representation of image data as captured and stored in an embodiment of the invention; and

FIG. 8 shows a schematic representation of a video frame as played back in an embodiment of the invention

FIG. 9 shows a grid pattern used for image capture and playback according to an embodiment of the invention;

FIG. 10 shows a geometric relationship between captured image data viewpoints and polygonal objects to be rendered according to an embodiment of the invention; and

FIGS. 11a and 11b show image frames including captured image data and polygonal objects rendered based on different viewpoints, according to an embodiment of the invention.

### DETAILED DESCRIPTION OF THE INVENTION

The invention provides a method of capturing image data for subsequently generating a video signal comprising a moving image in the form of a series of playback frames. The moving image represents movement of a viewer through a computer-generated virtual scene. The computer-generated virtual scene is generated using captured images by taking the captured images to have different viewpoints within the virtual scene, the viewpoints corresponding to different points of capture.

An image is stored for each of the viewpoints, by capturing a plurality of images based on the selection of a plurality of points of capture. The images may be captured photographically, or computer generated. If captured photographically, they are preferably captured sequentially.

At least some of said points of capture are distributed with a substantially constant or substantially smoothly varying average density across a first two-dimensional area. The viewpoints are distributed in at least two dimensions, and may be distributed in three dimensions.

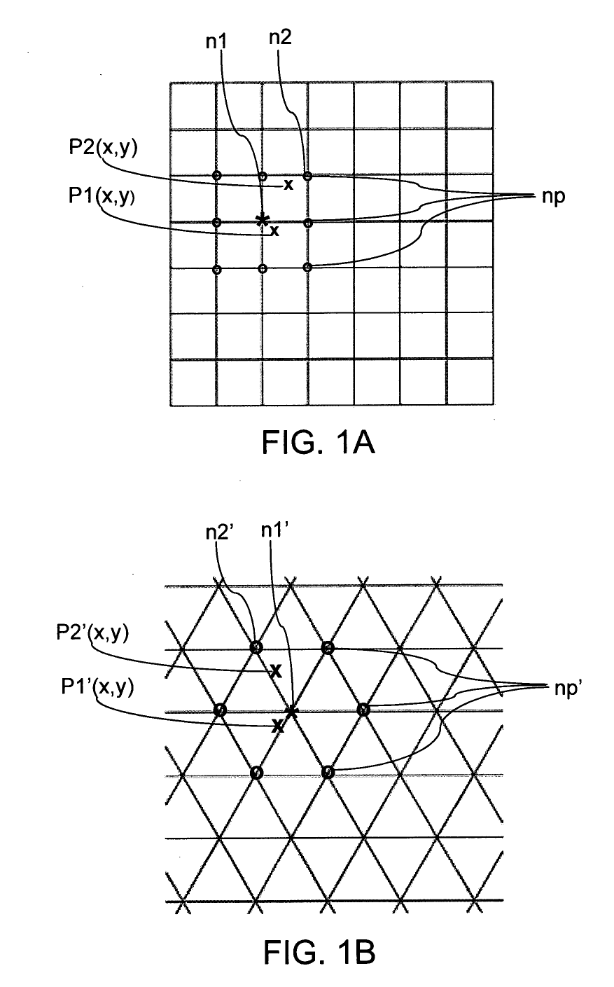

At least some of said points of capture are distributed in a regular pattern including a two-dimensional array in at least one two-dimensional area, for example in a grid pattern, if possible depending on the capture apparatus. One suitable grid formation is illustrated in FIG. 1A, which in this example is a two dimensional square grid. The viewpoints are located at each of the nodes of the grid.

The captured images preferably comprise images with a greater than 180° horizontal field of view, more preferably the captured images comprise images with a 360° horizontal field of view. Each stored image may be composed from more than one captured image. More than one photograph may be taken at each viewpoint, taken in different directions, with the captured images being stitched together into a single stored image for each viewpoint. It is preferable to use a single shot image capture process however to reduce geometry errors in the image capture which will be amplified on playback as many images are played back per second. Where the captured images are photographic images, these will have been captured at a plurality of points of capture in a real scene using camera equipment. The captured images will preferably have been captured using panoramic camera equipment.

During playback, the video frames are generated at a rate of at least 30 frames per second. The spacing of the viewpoints in the virtual scene, and also the real scene from which the virtual scene is initially captured, is determined not by the frame rate but the rate at which the human brain is capable of detecting changes in the video image. Preferably, the image changes at a rate less than the frame rate, and preferably less than 20 Hz. The viewpoint spacing is determined by the fact that the brain only really takes up to 14 changes in images per second. While we can see ‘flicker’ at rates up to 70-80 Hz. Thus the display needs to be updated regularly, at the frame rate, but the image only needs to really change at about 14 Hz. The viewpoint spacing is determined by the speed in meters per second, divided by the selected rate of change of the image. For instance at a walking speed of 1.6 m/s images are captured around every 50 mm to create a fluid playback. For a driving game this might be something like one every meter (note that the calculation must be done for the slowest speed one moves in the simulation). In any case, the points of capture, at least in some regions of said real scene, are preferably spaced less than 5 m apart, at least on average. In some contexts, requiring slower movement through the scene during playback, the points of capture, at least in some regions of said real scene, are spaced less than 1 m apart, at least on average. In other contexts, requiring even slower movement, the points of capture, at least in some regions of said real scene, are spaced less than 10 cm apart, at least on average. In other contexts, requiring yet slower movement, the points of capture, at least in some regions of said real scene, are spaced less than 1 cm apart, at least on average.

The capturing comprises recording data defining the locations of viewpoints in the virtual scene. For example, the viewpoints locations may correspond to the locations of points of capture in said real scene. A position of each point of capture may thus be recorded as location data associated with each viewpoint, for subsequent use in selecting the viewpoint when the position of the viewer is close to that viewpoint when moving through the virtual scene.

Reverting to FIG. 1A, it can be seen that the node of the grid, representing a plurality of points of capture and image storage, are distributed relative to a first point of capture, let us take for example point n1, in at least two spatial dimensions. The points of capture are distributed around point n1, across four quadrants around the first point of capture.

Whilst FIG. 1A illustrates a square grid, at least some of the points of capture may be distributed in a non-square grid across the first two-dimensional area. In an alternative embodiment, at least some of the points of capture are distributed in a triangular grid across the first two-dimensional area, as shown in FIG. 1B.

Alternatively, or in addition, the at least some of the points of capture may be distributed in an irregular pattern across the first two-dimensional area—this may simplify the capture process. In this case, images are captured which irregularly, but with a constant or smoothly varying average density, cover the area. This still allows the playback apparatus to select the nearest image at any one time for playback—or blend multiple adjacent images, as will be described in further detail below

Different areas may be covered at different densities. For example, an area in a virtual environment which is not often visited may have a lower density of coverage than a more regularly visited part of the environment. Thus, the points of capture may be distributed with a substantially constant or smoothly varying average density across a second two-dimensional area, the second two-dimensional area being delineated with respect to the first two-dimensional area and the average density in the second two-dimensional area being different to the average density in the first two-dimensional area.

The viewpoints may distributed across a planar surface, for example in a virtual scene representing an in-building environment. Alternatively, or in addition, the viewpoints may be distributed across a non-planar surface, for example in a virtual scene representing rough terrain, in a driving game for example. If the surface is non-planar, the two dimensional array will be parallel to the ground in the 3rd dimension, i.e. it will move with the ground. The terrain may be covered using an overlay mesh—the mesh may be divided into triangles which include a grid pattern inside the triangle similar to that shown in FIGS. 1A or 1B, and the surface inside each triangle will be flat (and the triangles will in some, and perhaps all cases, not be level). All triangles will be on a different angle and at a different height from each other, to cover the terrain. During the capture process, it is possible to survey the area before scanning it, and create a 3d mesh of triangles, where all neighbouring triangle edges and vertices line up. The capture apparatus can be moved around collecting data in each of the triangles sequentially.

Reverting again to FIG. 1A, during playback, a video signal comprising a moving image in the form of a series of playback frames is generated using stored images by taking the stored images, which are stored for viewpoints at each of the nodes n of the grid, according to the current position P (defined by two spatial coordinates x,y) of the viewer. Take for example an initial position of the viewer P1(x,y), as defined by a control program which is running on the playback apparatus—for example a video game program which tracks the location of the viewer as the player moves through the virtual scene. The position of the viewer is shown using the symbol x in FIG. 1A. A first stored image based on the selection of a first viewpoint n1 which is closest to the initial position P1(x,y). The playback apparatus then generates a first playback frame using the first stored image. More than one playback frame may be generated using the same first stored image. The position of the viewer may change. The viewer, in a preferred embodiment, may move in any direction in at least two dimensions. A plurality of potential next viewpoints np, shown using the symbol o in FIG. 1A, are distributed around the initial viewpoint n1. These are distributed in all four quadrants around the initial viewpoint n1 across the virtual scene. The viewer is moved to position P2(x,y). The playback apparatus selects a next viewpoint n2 from the plurality of potential next viewpoints distributed relative to the first viewpoint across the virtual scene, on the basis of proximity to the current position of the viewer P2(x,y) then selects a second stored image on the basis of the selected next viewpoint; and generates a subsequent playback frame using the second stored image.

The generating of playback frames may comprise generating playback frames based on selected portions of the stored images. The selected portions may have a field of view of less than 140°, and the playback equipment in this example also monitors the current viewing direction in order to select the correct portion of the image for playback. In one embodiment, the selected portions have a field of view of approximately 100°.

As described above, the playback method comprises receiving data indicating a position of the viewer in the virtual scene, and selecting a next viewpoint on the basis of the position. The selecting comprises taking into account a distance between the position and the plurality of potential next viewpoints in the virtual scene. The method preferably comprises taking into account the nearest potential next viewpoint to the position and comprises taking into account a direction of travel of the viewer, in addition to the position. The playback apparatus may receive a directional indication representing movement of the viewer, and calculating the position on the basis of at least the directional indication.

In preferred embodiments of the invention, the images are captured using an automated mechanically repositionable camera. The automated mechanically repositionable camera is moved in a regular stepwise fashion across the real scene.

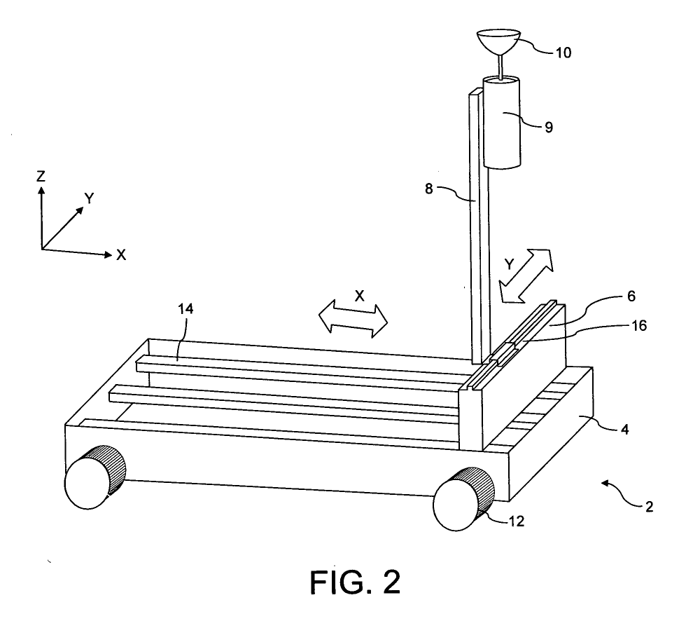

FIG. 2 shows an image capture device in a first embodiment, comprising a base 4, a moveable platform 6, a turret 8, and a camera 9. The base 4 is mounted on wheels 12 whereby the device is moved from one image capture position to another. The moveable platform 6 is mounted on rails 14 running along the base 4 to provide scanning movement in a first direction X. The turret 8 is mounted on a rail 16 which provides scanning movement in a second direction Y, which is perpendicular to the first direction X. Note that the rails 14 may be replaced by high-tension wires, and in any case the moveable platform 6 and the turret 8 are mounted on the rails or wires using high precision bearings which provide sub-millimetre accuracy in positioning both the first and second directions X, Y.

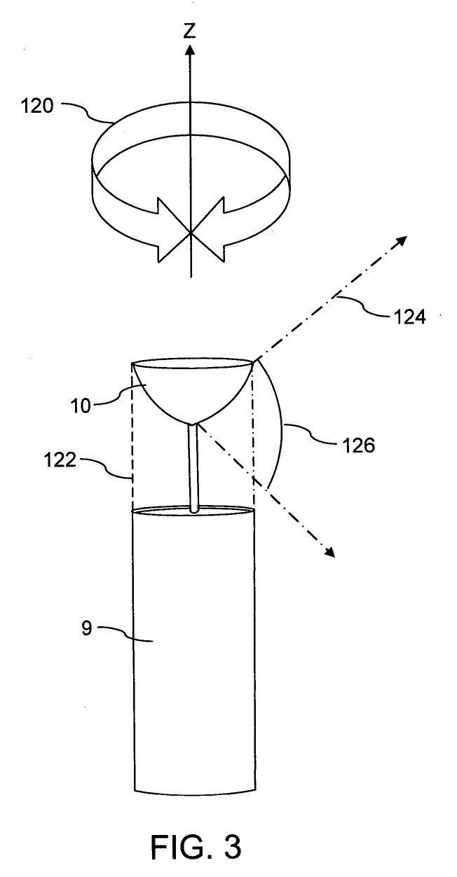

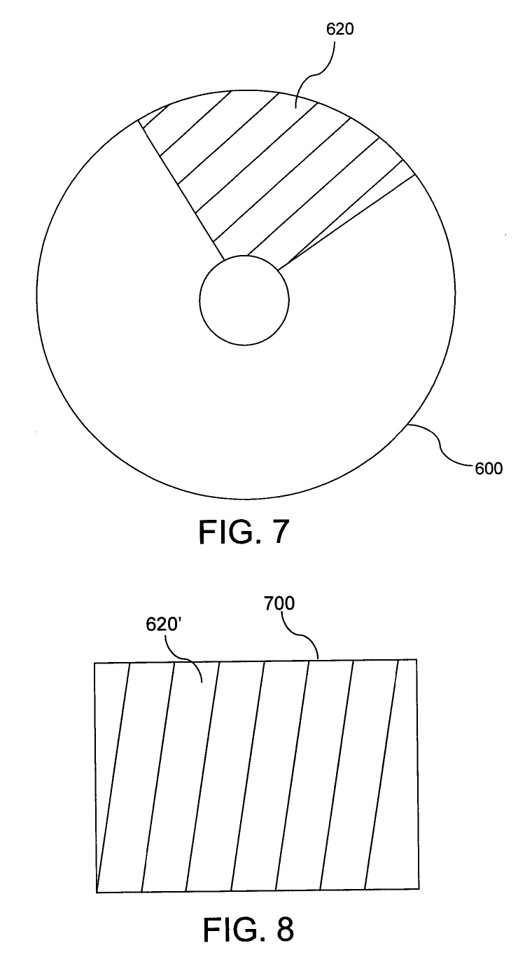

Mounted above the camera 9 is a panoramic imaging mirror 10, for example the optical device called “The 0-360 One-Click Panoramic Optic”™ shown on the website www[dot]0-360[dot]com. This is illustrated in further detail FIG. 3. The optical arrangement 10 is in the form of a rotationally symmetric curved mirror, which in this embodiment is concave, but may be convex. The mirror 10 converts a 360 degree panoramic image captured across a vertical field of view 126 of at least 90 degrees into a disc-shaped image captured by the camera 9. The disc-shaped image is shown in FIG. 7 and described in more detail below.

In the image capture device shown in FIG. 2, the base may have linear actuators in each corner to lift the wheels off the ground. It helps level the image capture apparatus on uneven terrain, but also helps transfer vibration through to the ground—to reduce lower frequency resonation of the whole machine during image capture. A leveling system may also be provided on the turret itself. This allows fine calibration to make sure the images are level.

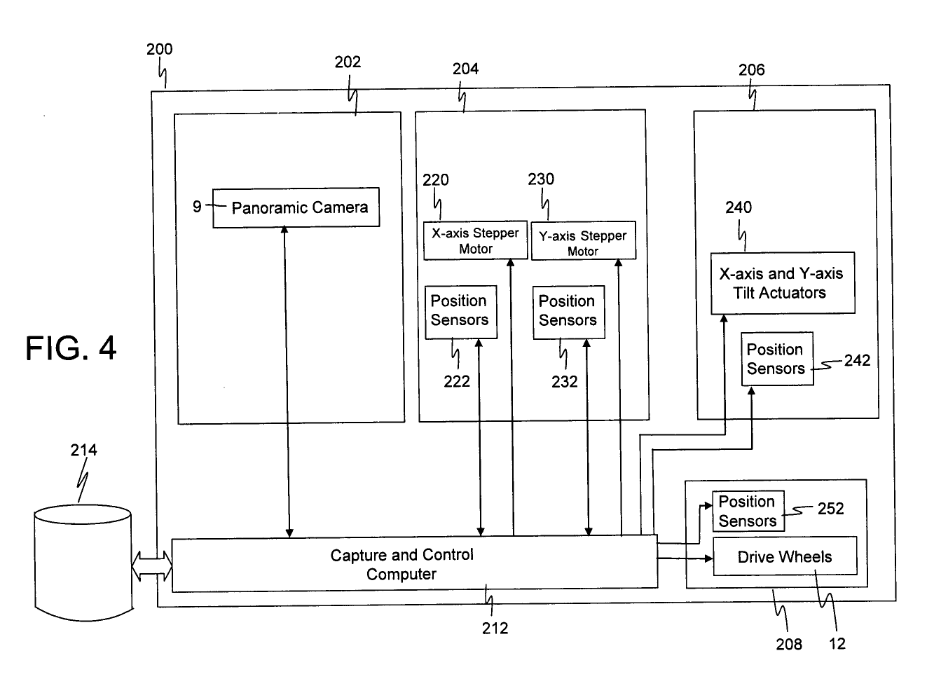

FIG. 4 shows a control arrangement for the device illustrated in FIG. 2. The arrangement includes image capture apparatus 202 including the panoramic camera 9, x- and y-axis control arrangement including stepper motors 220, 230, and corresponding position sensors 222, 232, tilt control arrangement 206 including x-axis and y-axis tilt actuators 240, and corresponding position sensors 242, and drive arrangement 208, including drive wheels 12 and corresponding position sensors 252. The control arrangement is controlled by capture and control computer 212, which controls the position of the device using drive wheels 12. When in position, the turret 8 is scanned in a linear fashion, row by row, to capture photographic images, which are stored in media storage device 214, in a regular two-dimensional array across the entire area of the base 4. The device is then moved, using the drive wheels 12, to an adjacent position, and the process is repeated, until the entire real area to be scanned has been covered.

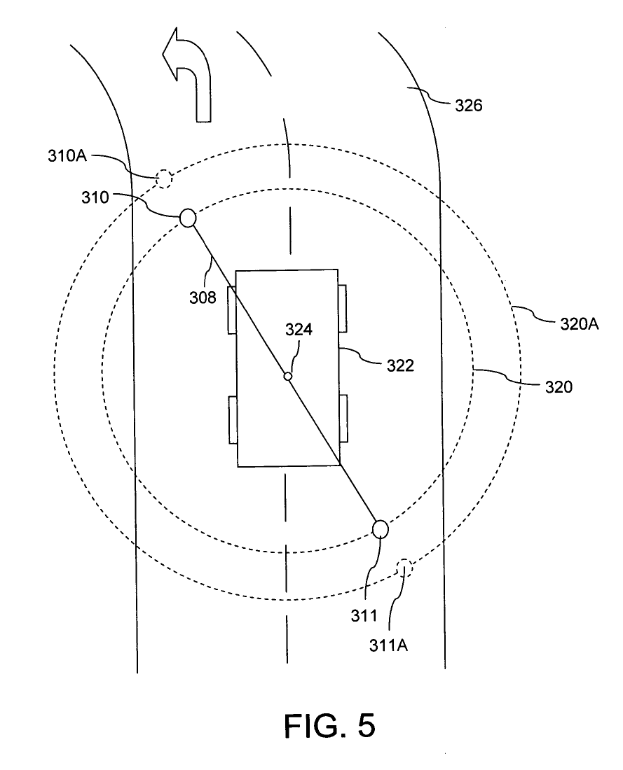

FIG. 5 shows an alternative image capture device. In this embodiment the image capture device is mounted on a human-controlled vehicle 322, for example a car. The device includes a rotating pole 308, at either end of which is mounted a camera 310, 311, each camera in this embodiment not being panoramic but having at least a 180 degree horizontal field of view. In use, the pole 308 is rotated and images are captured around a circular set of positions 320 whilst the vehicle is driven forwards, thus capturing images across a path along which the vehicle 322 is driven. The pole 308 may be extendable to cover a wider area, as shown by dotted lines 310A, 311A, 320A.

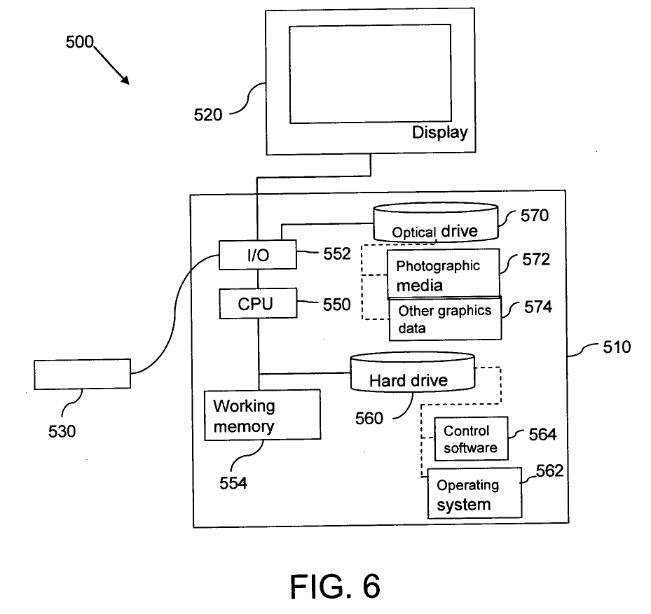

FIG. 6 illustrates playback equipment 500, according to an embodiment of the invention. The playback equipment 500 includes a control unit 510, a display 520 and a man-machine interface 530. The control unit 510 may be a computer, such as a PC, or a game console. In addition to conventional I/O, processor, memory, storage, and operating system components, the control unit 510 additionally comprises control software 564 and stored photographic images 572, along with other graphics data 574. The control software 564 operates to monitor the position of the viewer in a virtual scene, as controlled by the user using man-machine interface 530. As described above, the control software generates video frames using the stored images 572, along with the other graphics data 574, which may for example define an object model associated with the stored images 572, using the process described above.

FIG. 7 illustrates an image 600 as stored. The image 600 includes image data covering an annular area, corresponding to the view in all directions from a particular viewpoint. When the viewpoint is selected by the playback apparatus, the playback apparatus selects a portion 620 of the stored image corresponding to the current direction of view of the viewer. The playback apparatus 500 then transforms the stored image portion 620 into a playback image 620′, by dewarping it and placing the data as regularly spaced pixels within a rectangular image frame 700, shown in FIG. 8. When conducting the transformation, a good way to do it is to map it onto a shape which recreates the original environment. For some camera setups, this will mean projecting it on the inside of a sphere. On others it might mean just copying it to the display surface.

### Further Embodiments of Capture Apparatus

In a further embodiment of the invention, the image capture apparatus may be ceiling-mounted within a building. It may be used for capturing an artificial scene constructed from miniatures (used for flight simulators for instance).

In a further embodiment, the image capture apparatus is wire-mounted or otherwise suspended or mounted on a linear element, such as a pole or a track. The capture device obtains a row of images then the linear element is moved. This can be used for complex environments like rock faces or over areas a ground-mounted image capture apparatus is unable to be placed. The wire or other linear element may be removed from the images digitally.

A two step photographing process may be used—each point gets two photographs rather than one. This may be done by using a wide angle lens (8 mm or 180 degrees). The image capture apparatus takes all photographs in its grid area, then rotates the camera a half turn, then takes them all again.

The number of points of capture is preferably at least 400 per square meter, and in a preferred embodiment the number per square meter is 900, and where two photographs are taken per point, there are 1800 raw photographs per square meter.

In a further embodiment of the invention, an image capture device is mounted inside a building, for example within a rectangular room. High tension wires or rails are run in parallel down each side of the room. Strung between these wires or rails is a pole (perpendicular to wires or rails) which can extend or shrink. This extends to pressure itself between two opposite walls. This gives a stable platform to photograph from. The camera runs down one side of the pole taking shots (the camera extends out from the pole so it can't be seen in the image). Then the camera is rotated 180 degrees and photographs in the other direction. The positions selected are such that all images taken in the first direction have another image from another position in the alternate direction to be paired with. The pole then shrinks, moves along the wires to the next position, and repeats. This mechanism allows for a room to be scanned very quickly without any human intervention.

A further embodiment of the invention is ground-based and has a small footprint but can get images by extending out from its base. This means that less of the image is taken up with image capture apparatus and less of the image is therefore unusable. This is achieved by using two ‘turntables’ stacked on top of each other. These are essentially stepper motors turning a round platform supported by two sandwiched, pre-loaded taper bearings (which will have no roll or pitch movement—only yaw). The second one is attached to the outside of the first. The overlap would be roughly 50%, so the center of the next turntable is on the edge of the one below. Alternatively, three units may be used, with a base of, say, 300 mm diameter, but are a whole are capable of reaching all positions and orientations within 450 mm radius from the base. The base is ballasted to support the levered load, and for this we are proposing to use sand/lead pellets/gel or some other commonly available ballast stored in a ballast tank. This will allows the image capture apparatus to be lightweight (less than 32 kg including transport packaging)—when being transported and to increase stability in use by filling up the ballast tank at its destination.

### Three Dimensional Array

In a further embodiment, the viewpoints are distributed across a three-dimensional volume, for example for use in a flight simulator. The viewpoints may be arranged in a regular 3D array.

### Shadow Removal

The images are preferably captured in a manner to avoid movement of shadows during the course of scanning of the area, or shadow removal is employed. The former case can be achieved as follows:

1) Static light. This is done at night under ‘night time sun’ type apparatus. This prevents shadow movement during the course of picture-taking.
2) Nearly static light—overcast days, again shadows do not move during the course of picture-taking.
Shadow removal may be implemented using the following approaches:
3) Multi image—take image on overcast day and on sunny day at same place and use overcast day to detect large shadows.
4) Multi image—take one image in early morning and one in late afternoon.

Multi image shadow removal can be achieved by comparing the two pictures and removing the differences, which represent the shadows. Differences may be removed using a comparison algorithm, for example by taking the brightest pixels from each of two pictures taken in the same location.

### Image Compression

In one embodiment, in which a large capacity storage device is provided, the images are stored discretely. In other embodiments, the images are not stored discretely but are compressed for increased efficiency. They may be compressed in particular blocks of images, with a master ‘key’ image, and surrounding images are stored as the difference to the key. This may be recursive, so an image can be stored where it is only storing the difference between another image which is in turn stored relative to the key. A known video compression algorithm may be used, for example MPEG4 (H.264 in particular), to perform the compression/decompression. Where the stored images are stored on a storage device such as an optical disk, compression is used not just because of storage space, but for the ability to retrieve the data from the (relatively slow) disk fast enough to display.

Recovering Physics Data from the Images

The object model accompanying the stored images may be generated from the stored images themselves. 3D point/mesh data may be recovered from the images for use in physics, collision, occlusion and lighting calculations. Thus, a 3D representation of the scene can be calculated using the images which have been captured for display. A process such as disparity mapping can be used on the images to create a ‘point cloud’ which is in turn processed into a polygon model. Using this polygon model which is an approximation of the real scene, we can add 3D objects just like we would in any 3D simulation. All objects, or part objects, that are occluded by the static captured environment are (partially) overwritten by the static image.

Alternatively, or in addition, the 3D representation of the scene may be captured by laser scanning of the real scene using laser-range finding equipment.

### Multiple Image Blending

In the embodiments described above, the image closest to the location the viewer is standing is selected and the part of it corresponding to the user's direction of view (or all of it in a 360 degree viewing system such as CAVE) is displayed. In some cases multiple images are selected and combined. This can be likened to ‘interpolation’ between images. Metadata can be calculated and stored in advance to aid/accelerate this composition of multiple images.

### Pre-Caching

Pre-caching is used in case of use of a storage device for which access time is insufficiently fast. Using a hard disk, access time is around 5 ms, which is fast enough to do in real time. However using an optical the access time is far slower, in which case the control program predicts where the viewer is going to go in the virtual scene, split the virtual scene into blocks (say, 5 m×5 m areas) and pre-load the next block while the viewer is still in another area.

### Further Embodiments Including Image Compression

The stored image data captured during sampling of a scene and/or a motion picture set is preferably compressed to reduce the storage requirements for storing the captured image data. Reducing the storage requirements also decreases the processing requirements necessary for displaying the image data. Selected sets of captured image data are stored as compressed video sequences. During playback the compressed video sequences are uncompressed and image frame portions corresponding to the viewer's viewing perspective are played back simulating movement of the viewer in the virtual scene.

In one embodiment the sequence of events, for storing images as video sequences, in accordance with a preferred embodiment, is to:

a) capture a plurality of images across a grid of capture nodes as illustrated in FIG. 1A or 1B; b) select a set of individual images which are adjacent and follow a substantially linear path of viewpoints together to form a video sequence; c) compress the video sequence using a known video compression algorithm such as MPEG.

Image data of a scene to be played back in a video playback environment, used in a computer-generated virtual scene to simulate movement of a viewer in the virtual scene, is captured according to the method described previously. Image data of the scene is sampled at discrete spatial intervals, thereby forming a grid of capture nodes distributed across the scene.

In a preferred embodiment not all the image data is stored with the same image resolution. A subset of the total set of capture nodes, herein referred to as “rest” nodes, are selected with a substantially even spatial distribution over the grid pattern, at which high resolution static images are stored. A substantially linear path of nodes lying between any two “rest” nodes correspond to images stored as video sequences for playback with a reduced image resolution, herein referred to as “transit” nodes. There may be a plurality of different “transit” nodes lying between any two “rest” nodes, and the images captured at “transit” node positions are preferably captured using camera equipment as previously disclosed.

During image storage when the viewpoint corresponds to a “rest” node, a high resolution image of the scene is stored. When the when the viewpoint corresponds to a “transit” node a lower resolution image is captured, preferably in a compressed video sequence. This process is repeated for all “rest” and “transit” nodes in the grid. Since the images captured at “transit” nodes are only displayed for a very short time as image frames within a “transit” image video sequence during playback, as described below, the effect of capturing the images at a lower resolution has a negligible effect on the user experience during playback of the “transit” image video sequence.

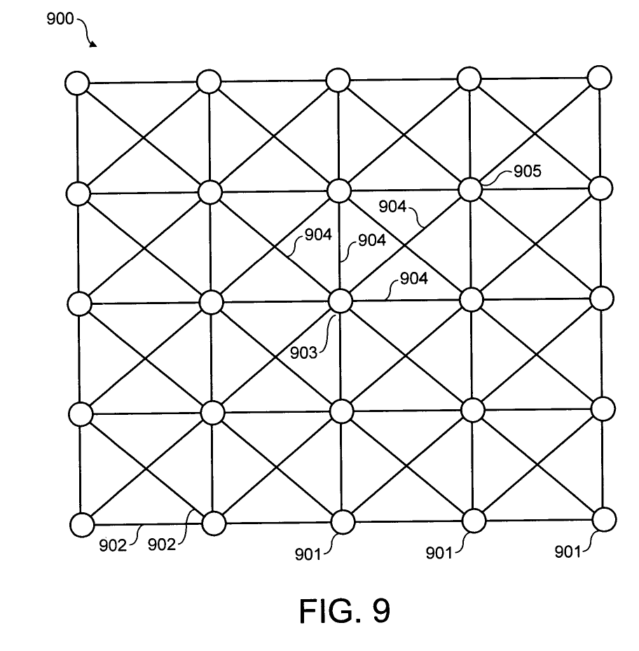

FIG. 9 illustrates a grid pattern 900 according to a preferred embodiment of the present invention. The grid pattern is comprised of a number of “rest” nodes 901. The lines 902 connecting neighbouring “rest” nodes correspond to “transit” image video sequences. The “transit” image video sequences 902 are comprised of a plurality of “transit” nodes (not shown in FIG. 9) which correspond to positions where low resolution image data of the scene is played back. The “transit” images captured at “transit” node positions lying between any two “rest” nodes are stored as compressed video sequences 902. The video sequences are generated by displaying the individual “transit” images captured at each “transit” node position in a time sequential manner. The video sequence is compressed using redundancy methods, such as MPEG video compression or other such similar methods. Adjacent video frames in the video sequence are compressed, wherein the redundant information is discarded, such that only changes in image data between adjacent video frames are stored. In preferred embodiments it is only the compressed video sequence 902 which is stored for playback, as opposed to storing each individual image captured at each “transit” node position. Compression methods using redundancy greatly reduce the storage space required to store the sampled image data of a scene.

The storage space required is significantly reduced by storing a plurality of “transit” image data, lying between designated “rest” nodes, as a single compressed “transit” image video sequence.

Each “rest” node is joined to an adjacent “rest” node by a “transit” image video sequence which may be thought of as a fixed linear path connecting two different “rest” nodes. For example “rest” node 903 has 8 adjacent “rest” nodes, and is connected to these adjacent “rest” nodes by 8 different fixed paths corresponding to 8 different “transit” image video sequences 904.

During playback if a viewer is initially positioned at “rest” node 903 and the viewpoint is to be moved to a position corresponding to the position of adjacent “rest” node 905, then the “transit” image sequence 904, which may be thought of as a fixed path connecting “rest” nodes 903 and 905, is played back simulating the viewer's movement from the first “rest” node position 903 to the second “rest” node position 905 within the virtual scene. The number of different directions of travel of a viewer is determined by the number of different fixed paths connecting the current “rest” node position of the viewer to the plurality of all adjacent “rest” nodes. The fixed paths are “transit” image video sequences and therefore the number of different directions of travel of a viewer is the number of different “transit” video sequences connecting the “rest” node corresponding to the viewer's current position within the virtual scene, to the plurality of adjacent “rest” nodes. A viewer can only travel in a direction having a “transit” image video sequence 904 associated with it. For example a viewer positioned at “rest” node 903 has a choice of moving along 8 different fixed paths, corresponding to the number of different “transit” image video sequences, connecting “rest” node 903 to its adjacent “rest” nodes.

During playback a “rest” node position is the only position where the viewer can be stationary and where the direction of travel during viewing may be altered. Once a viewer has selected a direction of travel corresponding to a particular “transit” image video sequence, the video sequence is displayed in its entirety, thereby simulating movement of the viewer within the computer-generated virtual scene. The user may not change his direction of travel until reaching a next “rest” node. The viewer may however change his viewing perspective whilst travelling along a fixed path corresponding to a “transit” image video sequence, seeing as the individual compressed “transit” image video frames.

According to one embodiment in order to display the compressed “transit” image video sequence, a dewarp is performed on 360° image frames of the compressed video sequence. The 360° images are stored as annular images, such as illustrated in FIG. 7. When conducting the transformation, a convenient way of doing it is to map it onto a shape which recreates the original environment. According to preferred embodiments of the present invention during playback the 360° image frames of the “transit” image video sequence are projected onto the inside surface of a sphere. In alternative embodiments the 360° image frames are projected onto the interior surface of a cube or a cylinder.

In an alternative embodiment the “transit” images are mapped onto the inside surfaces of a desired object prior to compression. For example it may be desired to project the annular image onto the interior surfaces of a cube. The video sequences may for example be stored as a plurality of different video sequences, for example 6 distinct vide sequences which are mapped onto the different surfaces of a cube.

The speed at which the “transit” image video sequences are played back is dependent on the speed at which the viewer wishes to travel through the virtual scene. The minimum speed at which the “transit” image video sequence may be played back is dependent on the spacing of the “transit” nodes and speed of travel of the viewer.

The same compressed “transit” image video sequences may be played back in both directions of travel of a viewer. For example turning to FIG. 9, the same “transit” video sequence is played back to simulate movement from “rest” node 903 to “rest” node 905, and for movement from “rest” node 905 to “rest” node 903. This is achieved by reversing the order in which the “transit” image video frames are played back and by changing the portion of the stored annular images, corresponding to the viewer's viewpoint direction, selected for display.

During simulation of a viewer's movement in the virtual scene, a viewer is not obliged to stop at a “rest” node once a selected “transit” image video sequence has been displayed in its entirety. A viewer may decide to continue moving in the same direction of travel and the next “transit” image video sequence is played back, without displaying the “rest” node image lying between both “transit” image video sequences.

### Further Embodiments Including Polygon Integration

The object model accompanying the stored images may be generated from the stored images themselves. 3D point/mesh data may be recovered from the images for use in physics, collision, occlusion and lighting calculations. Thus, a 3D representation of the scene can be calculated using the images which have been captured for display. A process such as disparity mapping can be used on the images to create a ‘point cloud’ which is in turn processed into a polygon model. Using this polygon model which is an approximation of the real scene, we can add 3D objects just like we would in any 3D simulation. All objects, or part objects, that are occluded by the static captured environment are (partially) overwritten by the static image.

Alternatively, or in addition, the 3D representation of the scene may be captured by laser scanning of the real scene using laser-range finding equipment.

In an alternative embodiment real-world measurements of the scene are stored with captured image data of the scene. This facilitates the generation of a 3D polygonal model of the scene from the captured image data.

Each of the different embodiments will be discussed in turn.

By comparing the different captured perspective images of the scene a ‘point cloud’ may be created, by comparing all 360° panoramic images of the scene captured in the grid pattern. The grid pattern may be thought of as an N×M array of 360° panoramic images captured at different positions distributed throughout the scene. Comparison of the N×M array of 360° panoramic images allows accurate disparity data between different captured images of the scene to be calculated. The disparity data allows geometrical relationships between neighbouring image points to be calculated. In certain embodiments the geometrical distance between each image pixel is calculated. In embodiments where a 3D model is required, a 3D polygonal model of the scene is constructed using the disparity data, calculated from comparison of the 2D images contained in the N×M array of images of the scene. A ‘point cloud’ containing accurate geometrical data of the scene is generated wherefrom a 3D polygonal model may be constructed.

Traditional disparity mapping techniques usually rely on comparison of two different perspective images, wherefrom disparity data is calculated. Comparison of an N×M array of different 2D perspective images is advantageous over traditional disparity mapping methods in that more accurate disparity data is calculated.

In an alternative embodiment real-world measurement data of the scene is stored with captured image data of the corresponding scene, such as the physical dimensions of the scene being captured and/or the physical dimensions of any pertinent objects within the scene. In this way the geometrical relationship between neighbouring image points may be easily calculated using the real-world measurements associated with the scene. In certain embodiments once the distances between image points are known then, for example if required, one may define an arbitrary coordinate frame of reference and express the position of each image point as a coordinate with respect to the arbitrarily chosen coordinate frame, thereby associating a positional coordinate to each image point. The coordinate position of a particular image point may be calculated using the real-world measurement data associated with the image containing the image point. Once the geometrical relationships between any two image points is known a 3D polygonal model may be constructed from the 2D image data of the scene, should this be required. A 3D polygonal model may be constructed by associating the vertices of a polygon with image points whose positional coordinate data is known. The accuracy of a 3D polygonal model constructed in this way, is proportional to the distance between known positional coordinates of image points and hence to the size of the polygons approximating the scene. The smaller the separation between known positional coordinate points, the smaller the polygons approximating the scene and hence the more accurate the 3D polygonal model is of the scene. Similarly the larger the distance separating known positional coordinate points, the larger the polygons approximating the scene and the less accurate the resulting 3D polygonal model is of the scene.

For example if one desires to generate a virtual reality walkthrough of a selected scene where the viewer does not see dynamic objects within the scene, then a 3D polygonal model of the scene may not be required. One can simply project a dewarped image of the scene corresponding to the viewer's viewpoint onto a viewing screen. If however, the viewer is to interact with objects or otherwise see dynamic objects within the virtual scene, then 3D polygonal models may be used.

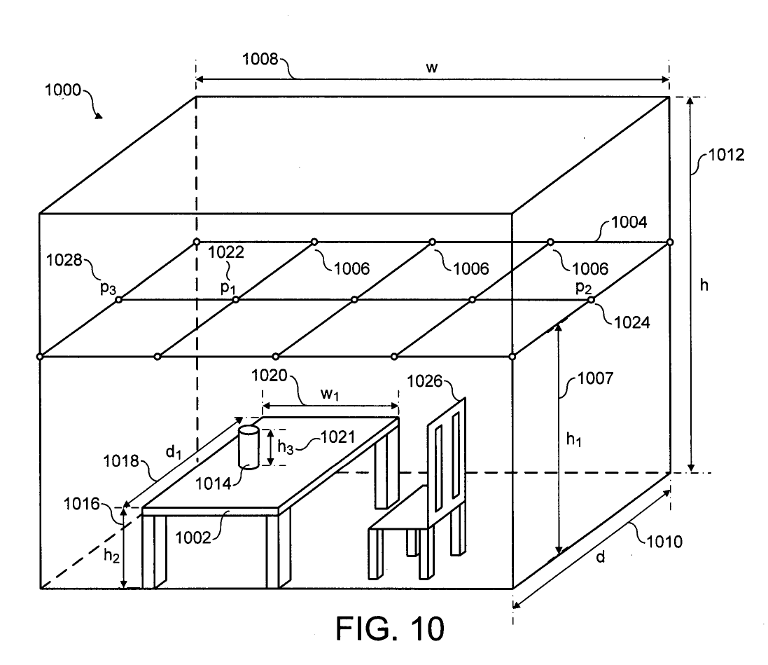

Consider a room containing a table from which a virtual scene is constructed. FIG. 10 is an example of a virtual scene 1000 created from image data of a physical room containing a table 1002 and a chair 1026. Furthermore the capture grid pattern 1004 representing the plurality of different viewpoint perspectives 1006 of the virtual scene 1000 is also depicted. The image data of the real physical scene has been captured at a height h₁ 1007 above the ground, therefore all different viewpoints of the scene are from a height h₁ 1007 above the ground. Real world measurements of the scene have also been taken, for example the width w 1008, depth d 1010 and height h 1012 of the room as well as the dimensions h₂ 1016, d₁ 1018 and w₁ 1020 of the table 1002 are stored with the captured image data. In this particular example it is desired to place a synthetically generated polygonal object, for example cup 1014 on top of a real-world object in a captured image, which in this case is a table 1002. We wish to introduce a synthetic object in the virtual scene 1000 which has no physical counterpart in the corresponding physical scene. The synthetic object (the cup) is introduced into the scene, making the synthetic object appear as if it was originally present in the corresponding real physical scene. Furthermore as the viewer navigates between different perspective images of the scene the perspective image of the synthetic object must be consistent with the perspectives of all other objects and/or features of the scene. In preferred embodiments this may be achieved by rendering a generated 3D model of the cup placed at the desired location within the virtual scene 1000. From the real-world measurements associated with the physical scene it is known that the table 1002 has a height of h₂ 1016 as measured from the floor, a depth d₁ 1018 and a width wᵢ 1020. The desired position of the cup is in the centre of the table 1002 at a position corresponding to w₁/2, d₁/2 and h₂. This is achieved by generating a 3D polygonal model of the cup and then placing the model at the desired position within the virtual scene 1000. The cup is correctly scaled when placed within the virtual scene 1000 with respect to surrounding objects and/or features contained within the virtual scene 1000. Once the 3D model is correctly positioned then the 3D model is rendered to produce a correctly scaled perspective image of the synthetically generated object within the virtual scene 1000. In certain preferred embodiments the entire scene does not need to be rendered only the 3D model of the synthetic object requires rendering to generate a perspective image of the object, as the different perspective images of the virtual scene 1000 have already been captured and stored.

Consider a plan perspective (from above) image of the cup 1014 resting on the table 1002 as it would appear to a viewer positioned at P₁ 1022 looking down on the table 1002. If the cup 1014 has a desired height of h₃ 1021 and is placed on the table 1002 which itself stands at a height of h₂ 1016 above the ground, the apparent distance from a camera positioned at node P₁ 1022 would be h₁−(h₂+h₃). Accordingly when a plan perspective image of the cup 1014 is rendered it appears as if the image of the cup 1014 had been captured from a camera placed at position P₁ at a height h₁−(h₂+h₃) above the cup 1014. If the viewer navigating through the virtual scene was to move to position P₃ 1028, then a different perspective image of the cup must be rendered. Using the real world measurement data of the scene the distance of node P₃ 1028 from the cup 1014 and the perspective viewing angle can be calculated. This data is then used to render the correct perspective image of the cup 1014, from the 3D polygonal model of the cup 1014, as would be observed from position P₃ 1028. Such a mathematically quantifiable treatment is possible provided certain real world measurement information regarding the scene are known and provided that a 3D model of the cup is generated and placed in the scene. In particular the position of the synthetic object is known with respect to the viewing position of the viewer. In the above cited example the position of the cup 1014 is defined with respect to an object contained within an image of the scene, i.e. with respect to the table 1002. Additionally the distance of the capture grid pattern 1004 from the table 1002 is known and hence the position of the cup 1014 with respect to the capture grid nodes 1006 can be calculated for all node positions corresponding to the different perspective images of the scene. Regardless of the perspective image of the scene being displayed, if the real world measurements of the table 1002 are known then the synthetically generated cup 1014 can be positioned correctly at the centre of the table 1002 with the correct perspective, for all different node positions 1006. This ensures the perspective image of a synthetic object placed in the virtual scene 1000 is consistent with the perspective image of the scene, and therefore a viewer cannot distinguish between synthetically generated objects and objects originally present in the physical scene as captured. In the example described the only 3D polygonal model generated was for the synthetic object being integrated into the virtual scene 1000—i.e. the cup 1014.

In alternative embodiments one may wish to generate more 3D polygonal models, not only of synthetic objects being integrated into the virtual scene 1000 but also of objects and/or features physically present in the physical scene. This may be required when for example physics, collision, occlusion and lighting calculations are required. The above list is not exhaustive of the different situations where 3D polygonal models are necessary. The skilled reader will appreciate there are many examples where 3D polygonal models are required which have not been mentioned herein.

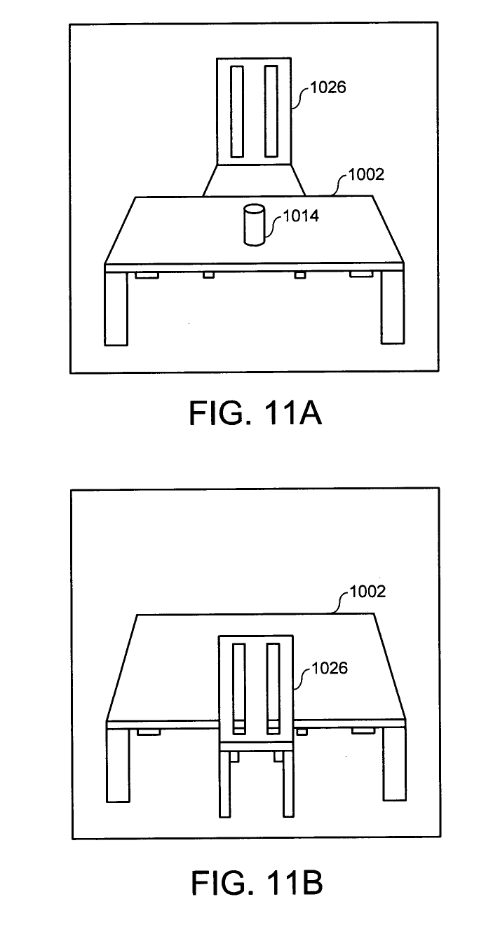

Returning to FIG. 10, consider the image of the chair 1026 in the virtual scene 1000 which is in the captured image data. Depending on the viewing position of a viewer the image of the cup 1014 may be obscured by the chair 1026. The same reference numerals will be used to refer to objects present in both FIG. 10 and FIGS. 11a) and 11b). FIG. 11a) depicts a perspective image of the table 1002, chair 1026 and cup 1014 as may be observed from node position P₃ 1028 of FIG. 10. If a viewer was to move to a position corresponding to node P₂ 1024 of FIG. 10, then the image of the cup 1014 should be blocked by the image of the chair 1026. To accurately represent such occlusion effects a 3D polygonal model of the chair 1026 is generated, otherwise when the 3D model of the cup 1014 is placed in the scene it will be overlaid on the combined image of table 1002 and chair 1026. A 3D model of the chair 1026 is generated using either real-world measurement data of the chair or disparity mapping, and a perspective image rendered corresponding to the correct viewing perspective. In this manner when the viewing perspective corresponds to node position P₂ 1024, the rendered image of the cup 1014 is occluded as illustrated in FIG. 11b. Similarly a 3D polygonal model of the table 1002 can also be used since from certain viewpoint positions parts of the chair 1026 are blocked from view, such as from position P₃ 1028 as illustrated in FIG. 11a). Generating a 3D polygonal model of the cup 1014, table 1002 and chair 1026 allows occlusion effects to be calculated. The 3D polygonal models of the chair 1026 and table 1002 have physical counterparts in the physical scene being virtually reproduced, whilst the cup 1014 has no physical counterpart. When rendering the correct perspective images of 3D polygonal models the position and orientation of the model with respect to the viewing position of the viewer is a necessary requirement. Associating geometric relationship data, based on real world measurement data, with captured image data helps to ensure the position of any subsequently generated 3D polygonal models is known with respect to the plurality of different viewing positions.

By generating 3D polygon models of objects within the virtual scene 1000, a viewer can also interact with such objects as previously mentioned. An image object having a 3D polygon model associated with it will be correctly scaled with respect to the viewing position and orientation of a viewer, regardless of where it is placed in the virtual scene 1000. For example if a viewer navigating in the virtual scene 1000 was to pickup the cup 1014 and place it on the floor in front of the table 1002 and was to then look at the cup from a position P₃ 1028 we would expect the perspective image of the cup 1014 to be different than when it was placed on the table 1002, and we would additionally expect the image to be slightly larger if the distance from the viewer is shorter than when the cup 1014 was placed on the table 1002. This is possible precisely because we are able to generate scaled 3D polygon objects using real-world measurement data associated with the physical scene being virtually reproduced.

The above embodiments are to be understood as illustrative examples of the invention. Further embodiments of the invention are envisaged. For example, in the above embodiments, the image data is stored locally on the playback apparatus. In an alternative embodiment, the image data is stored on a server and the playback apparatus requests it on the fly. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of generating a video signal comprising a moving image in the form of a series of playback frames, the moving image representing movement of a viewer through a different positions in a computer-generated virtual scene, wherein said computer-generated virtual scene is generated using stored images by taking said stored images to have different viewpoints within said virtual scene, the method comprising:
selecting a first stored image based on a relationship between a viewpoint related to said first stored image and a first position of said viewer in said virtual scene;
generating a first playback frame using at least said first stored image;
determining a next position of said viewer in said virtual scene from a plurality of potential next positions of said viewer in said virtual scene distributed across said virtual scene relative to the first position of said viewer in said virtual scene,
selecting a second stored image based on a relationship between a viewpoint related to said second stored image and said next position of said viewer in said virtual scene;
generating a subsequent playback frame using at least said second stored image,
wherein selecting said second stored image comprises taking into account a distance between said next position and said viewpoint related to said second stored image.

2. A method according to claim 1, wherein said generating of playback frames comprises generating a playback frame based on a plurality of said stored images.

3. A method according to claim 2, wherein said plurality of stored images are selected based on relationships between said plurality of viewpoints related to said second stored images and said next position of said viewer in said virtual scene.

4. A method according to claim 1, wherein said stored images are photographic images which have been captured at a plurality of points of capture in a real scene using camera equipment.

5. A method according to claim 1, comprising taking into account the nearest viewpoint, related to a stored image, to said next position, when selecting said second stored image.

6. A method according to claim 1, comprising taking into account a direction of travel of said viewer, in addition to said next position, when selecting said second stored image.

7. A method according to claim 1, comprising receiving a directional indication representing movement of the viewer, and calculating said next position on the basis of at least said directional indication.

8. A method according to claim 1, wherein said plurality of potential next positions are distributed relative to the first position across said virtual scene in at least two spatial dimensions.

9. A method according to claim 8, wherein said plurality of potential next positions are distributed across at least two adjacent quadrants around said first position, in said virtual scene.

10. A method according to claim 9, wherein said plurality of potential next positions are distributed across four quadrants around said first position, in said virtual scene.

11. A method according to claim 1, wherein at least some of said viewpoints related to stored images are distributed with a substantially constant or substantially smoothly varying average density across a first two-dimensional area in said virtual scene.

12. A method according to claim 11, wherein said at least some of said viewpoints related to stored images are distributed in a regular pattern including a two-dimensional array in said first two-dimensional area.

13. A method according to claim 12, wherein said at least some of said viewpoints related to stored images are distributed in a square grid across said first two-dimensional area.

14. A method according to claim 12, wherein said at least some of said viewpoints related to stored images are distributed in a non-square grid across said first two-dimensional area.

15. A method according to 14, wherein said at least some of said viewpoints are distributed in a triangular grid across said first two-dimensional area.

16. A method according to claim 1, wherein said at least some of said viewpoints related to stored images are distributed in an irregular pattern across said first virtual scene.

17. A method according to claim 1, wherein said at least some of said viewpoints related to stored images are distributed across a planar surface.

18. A method according to claim 1, wherein said at least some of said viewpoints related to stored images are distributed across a non-planar surface.

19. A method according to claim 1, wherein said at least some of said viewpoints related to stored images are distributed across a three-dimensional volume.

20. A method according to claim 1, wherein said generating of playback frames comprises transforming at least part of a stored image by projecting said part of the stored image onto a virtual sphere.

21. A method of generating a video signal comprising a moving image in the form of a series of playback frames, the moving image representing movement of a viewer through a computer-generated virtual scene, wherein said computer-generated virtual scene is generated using stored images by taking said stored images to have different viewpoints within said virtual scene, the method comprising:
selecting a first stored video image sequence;
generating a first set of playback frames using said first stored video image sequence;
selecting a first stored static image;
generating a second set of playback frames using said first stored static image.

22. A method according to claim 21, comprising selecting said first stored video image sequence when said viewer is moving through said scene, and selecting said first stored static image when said viewer is at rest in said scene.

23. A method storing image data for subsequently generating a video signal comprising a moving image in the form of a series of playback frames, the moving image representing movement of a viewer through a computer-generated virtual scene, wherein said computer-generated virtual scene is capable of being generated using captured images by taking said captured images to represent different viewpoints within said virtual scene, said viewpoints corresponding to different points of capture, the method comprising:
storing a plurality of stored video image sequences corresponding to said captured images;
storing a plurality of stored static images corresponding to said captured images;
wherein said stored video image sequences represent viewpoints which connect at least some of the viewpoints represented by said stored static images.

24. A method according to claim 23, wherein said stored video image sequences represent viewpoints arranged along substantially linear paths within said virtual scene.

25. A method according to claim 23, wherein said stored static images represent viewpoints which are distributed with a substantially constant or substantially smoothly varying average density across a first two-dimensional area or volume.

26. A method according to claim 23, wherein said stored static images represent viewpoints which are arranged in a regular grid.

27. A method of generating a video signal comprising a moving image in the form of a series of playback frames, the moving image representing movement of a viewer through a computer-generated virtual scene, wherein said computer-generated virtual scene is generated using stored images by taking said stored images to have different viewpoints within said virtual scene, the method comprising:
selecting a first stored image based on the selection of a first viewpoint;
rendering a first polygon-generated image object based on the selection of the first viewpoint;
generating a first playback frame using said first stored image and said first polygon-generated image object.

28. A method according to claim 27, comprising rendering said first polygon-generated image object based on a geometrical relationship between said first viewpoint and a polygonal object to be represented by said image object.

29. A method of storing image data for subsequently generating a video signal comprising a moving image in the form of a series of playback frames, the moving image representing movement of a viewer through a computer-generated virtual scene, wherein said computer-generated virtual scene is capable of being generated using said captured images by taking said captured images to have different viewpoints within said virtual scene, said viewpoints corresponding to different points of capture, the method comprising:
storing a plurality of images for playback based on the selection of a plurality of respective viewpoints,
storing data representing a polygonal object to be represented in said virtual scene;
storing data representing a geometrical relationship between said polygonal object an said viewpoints.

30. A computer-readable medium comprising code arranged to instruct a computer to generate a video signal comprising a moving image in the form of a series of playback frames, the moving image representing movement of a viewer through a different positions in a computer-generated virtual scene, wherein said computer-generated virtual scene is generated using stored images by taking said stored images to have different viewpoints within said virtual scene, the code being arranged to:
select a first stored image based on a relationship between a viewpoint related to said first stored image and a first position of said viewer in said virtual scene;
generate a first playback frame using at least said first stored image;
determine a next position of said viewer in said virtual scene from a plurality of potential next positions of said viewer in said virtual scene distributed across said virtual scene relative to the first position of said viewer in said virtual scene,
select a second stored image based on a relationship between a viewpoint related to said second stored image and said next position of said viewer in said virtual scene;
generate a subsequent playback frame using at least said second stored image,
wherein selecting said second stored image comprises taking into account a distance between said next position and said viewpoint related to said second stored image.
